(19) United States
(12) Patent Application Publication
(10) Pub. No.: US 2008/0053091 A1
(43) Pub. Date: Mar. 6, 2008

(54) Turbocharging Device and Control Method for Controlling the Turbocharging Device

(76) Inventor: Pierre Barthelet, Remiremont (FR)

Correspondence Address: Honeywell International;Patent Service, 101 Columbia Road, Mail Stop AB/2B, Morristown, NJ, 07962, US

(21) Appl. No.: 11/884,250

(22) PCT Filed: Feb. 16, 2005
(86) PCT No.: PCT/EP05/03450

§ 371 Date: Aug. 13, 2007

(51) Int. Cl. F02B 37/10; F02B 37/14; F02B 37/16; F02B 37/18; F02B 37/24; F02B 39/10

(52) U.S. Cl. 60/608

(57) ABSTRACT

A method for controlling an electrically assisted turbocharger (1,20,30,40,50) is provided. The turbocharger comprises a compressor assembly (3) having a compressor wheel for compressing a fluid to an engine (7), a turbine assembly (2) having a turbine wheel driven by an exhaust gas of the engine (7) and driving the compressor wheel (2), and an electric motor (4) for electrically driving the compressor wheel. Furthermore, at least the turbine assembly (2) comprises a variation means (10,21) for varying an operational condition of the turbine assembly (2). The method comprises the steps of judging that the actual operational condition of the engine (7) requires electrical driving of the compressor wheel, controlling said variation means (10,21) in accordance with a rotational speed of the engine (7) or in accordance with an engine load, and operating the electric motor (4) to drive the compressor wheel in accordance with a target operational condition of the engine 7.

The invention relates to a turbocharging device and to a control method for controlling the turbocharging device.

Turbochargers are well known and widely used in internal combustion engines. Exhaust gas coming from the engine is supplied to a turbine wheel which drives a compressor wheel via a common shaft. The compressor wheel compresses air which is charged to the combustion chambers of respective cylinders of the engine. The thus compressed air supplies an increased amount of oxygen to the combustion chamber to enhance the combustion so as to generate more power.

However, when the engine speed is low, the mass flow of the exhaust gas is also low, which results in low power being applied to the turbine wheel. As a result, the compressor wheel driven by the turbine wheel via the exhaust gas fails to provide a target boost pressure of the air supplied to the engine. As a result, the generation of more power in the engine is delayed until the engine speed is increased. This effect is known as “turbo-lag”.

Conventionally, there are different means known so as to attenuate the turbo-lag effect. For example, turbochargers can be equipped with a variable nozzle turbine (VNT) in which vanes can be operated so as to control the exhaust gas flow to the turbine wheel. When the engine speed is low and thus, the exhaust gas mass flow is low, the vanes are fully closed such that an inlet sectional area of a throat portion leading to the turbine wheel is reduced. This results in an increased turbine inlet pressure, which increases turbine power and gives a higher engine boost pressure. At high engine speeds and load, the vanes open, thereby increasing the turbine inlet sectional area.

Furthermore, the increasing pressure on fuel consumption of internal combustion engines drives the trend of downsizing the engines using turbochargers. However, downsized engines result in further deteriorated performance in low engine speed ranges while at the same time the high engine speed performance is maintained or even enhanced. Thus, the deficit in a torque at a low engine speed increases more and more while the conventional turbochargers, like the above mentioned VNT turbocharger, fail to counteract against these contradictory requirements of downsized engines.

Thus, there is a need to provide an improved turbocharger which can fulfil the requirements for downsized engines.

According to an aspect of the invention, the above need is met with a method for controlling an electrically assisted turbocharger according to claim 1 or 2. Modifications of the methods are set forth in the subclaims 3 to 12.

According to another aspect of the invention, the above need is met with a turbocharging device according to claim 13 or 14. Modifications of the turbocharging devices are set forth in the subclaims 15 to 24.

According to an exemplary embodiment of the invention, a method for controlling an electrically assisted turbocharger is provided, wherein the electrically assisted turbocharger comprises a compressor assembly having a compressor wheel for compressing a fluid to an engine, a turbine assembly having a turbine wheel driven by an exhaust gas of the engine and driving the compressor wheel, and an electric motor for electrically driving the compressor wheel, wherein at least the turbine assembly comprises a variation means for varying an operational condition of the turbine assembly. The method comprises the steps of judging that the actual operational condition of the engine requires electrical driving of the compressor, controlling said variation means in accordance with a rotational speed of the engine, and operating the electric motor to drive the compressor wheel in accordance with a target operational condition of the engine.

Thus, the electric motor and the variation means can be controlled such that they complement each other. For example, in a low engine speed range, the turbocharger can be assisted by the electric motor. Then, in a medium rotational speed range of the engine, the electric motor can be switched off while the variation means is maintained for a medium engine speed range. When the engine speed further increases, the variation means can be varied to adapt the turbocharger conditions to the higher speed range.

Thus, the map width, i.e. the operational range, of the turbocharger, is improved due to the optimal control of the electric motor and the variation means or, in other words, due to the concurrent operation of the electric motor and the variation means. As a result, the turbocharger is optimally controlled so as to counteract against above mentioned contradictory requirements of downsized engines especially for transient conditions. These transient conditions occur, for example, when the vehicle is to be accelerated.

According to another exemplary embodiment of the invention, a method for controlling an electrically assisted turbocharger is provided, wherein the electrically assisted turbocharger comprises a compressor assembly having a compressor wheel for compressing a fluid to an engine, a turbine assembly having a turbine wheel driven by an exhaust gas of the engine and driving the compressor wheel, and an electric motor for electrically driving the compressor wheel, wherein at least the turbine assembly comprises a variation means for varying an operational condition of the turbine assembly. The method according to this exemplary embodiment comprises the steps of judging that the actual operational condition of the engine requires electrical driving of the compressor, controlling said variation means in accordance with an engine load, and operating the electric motor to drive the compressor wheel in accordance with a target operational condition of the engine. Preferably, the engine load is represented by an amount of fuel injected into a cylinder of the engine.

Thus, the electric motor and the variation means can be controlled such that they complement each other. For example, in a low engine speed range, the turbocharger can be assisted by the electric motor. Then, in a medium rotational speed range of the engine, the electric motor can be switched off while the variation means is maintained for a medium engine speed range. When the engine speed further increases, the variation means can be varied to adapt the turbocharger operating conditions to the higher speed range.

Thus, the map width of the turbocharger is improved due to the optimal control of the electric motor and the variation means or, in other words, due to the concurrent operation of the electric motor and the variation means. As a result, the turbocharger is optimally controlled so as to counteract against above mentioned contradictory requirements of downsized engines especially for transient conditions.

Accordingly, the control of the turbocharger is especially optimal for steady state conditions of the engine at a low engine speed, for example when the vehicle is driving uphill and/or the load on the engine is increased while the engine speed remains substantially constant.

Furthermore, the judgement of the actual operational condition the engine may be determined based on the rotational speed of the engine. The judgement of the actual operational condition of the engine may also be determined based on a fuel quantity. Furthermore, the judgement of the actual operational condition of the engine may be determined based on a boost error.

Furthermore, the electrical driving of the compressor may be judged to be necessary if all the above conditions are met, namely if the rotational speed of the engine is within a certain range, the fuel quantity has reached a certain fuel quantity threshold value, and the boost error has reached a certain boost error threshold value.

Preferably, the compressor assembly is a fixed geometry compressor assembly, the turbine assembly is a waste gate turbine, and the variation means is a waste gate varying the amount of exhaust gas supplied to the turbine wheel. Then, the method preferably comprises the step of controlling a waste gate position so as to adjust the operational condition of the turbine wheel.

Thus, the turbocharger may be electrically assisted with the waste gate being closed when the engine speed is low, then, when the engine speed increases, the electric motor can be switched off while the waste gate remains closed. When the engine speed further increases to reach a predetermined value, the waste gate starts to open. As a result, the map width of the turbocharging device is enhanced.

Furthermore, the compressor assembly may be a fixed geometry compressor assembly, the turbine assembly may be a variable nozzle turbine, and the variation means may be a variable nozzle varying the flow of exhaust gas supplied to the turbine wheel. Then, the method may comprise the step of controlling a variable nozzle position so as to adjust the operational condition of the turbine wheel.

Thus, the turbocharger may be electrically assisted with the variable nozzle being closed when the engine speed is low, then, when the engine speed increases, the electric motor can be switched off while the variable nozzle remains closed. When the engine speed further increases to reach a predetermined value, the variable nozzle starts to open. As a result, the map width of the turbocharging device is enhanced.

Also, the compressor assembly may comprise a recirculation valve as a variation means and the method may further comprise the step of controlling the recirculation valve so as to adjust the operational condition of the compressor wheel.

Furthermore, the compressor assembly may be a variable geometry compressor comprising at least one vane as a variation means and the method may further comprise the step of controlling the position of the at least one vane so as to adjust the operational condition of the compressor wheel.

The electrically driven turbocharger may be supplied with electric power from a vehicle electrical network including an alternator, a controllable switch and a battery, wherein the switch may be switchable to connect/disconnect the electric motor to/from the alternator. Then, the method may further comprise the step of operating said switch in the beginning of the electrical driving of the compressor such that the electric motor is supplied with electric power from the battery only. Thus, since electric power for driving the electric motor is not consumed from the alternator being driven by the crank shaft of the engine when the electric motor demands for high electric power at low engine speeds, a drag torque on the crank shaft of the engine can be prevented.

According to another exemplary embodiment of the invention, a turbocharging device having an electrically assisted turbocharger and a control means for controlling said turbocharger is provided. The turbocharger further comprises a compressor assembly having a compressor wheel for compressing a fluid to an engine, a turbine assembly having a turbine wheel driven by an exhaust gas of the engine and driving the compressor wheel, and an electric motor for electrically driving the compressor wheel, wherein at least one of the compressor assembly and the turbine assembly comprises a variation means for varying an operational condition of the respective assembly. The control means judges that the actual operational condition of the engine requires electrical driving of the compressor, controls said variation means in accordance with a rotational speed of the engine, and operates the electric motor to drive the compressor wheel in accordance with a target operational condition of the engine. According to another exemplary embodiment of the invention, a turbocharging device having an electrically assisted turbocharger and a control means for controlling said turbocharger is provided. The turbocharger further comprises a compressor assembly having a compressor wheel for compressing a fluid to an engine, a turbine assembly having a turbine wheel driven by an exhaust gas of the engine and driving the compressor wheel, and an electric motor for electrically driving the compressor wheel, wherein at least one of the compressor assembly and the turbine assembly comprises a variation means for varying an operational condition of the respective assembly. The control means judges that the actual operational condition of the engine requires electrical driving of the compressor, controls said variation means in accordance with an engine load, and operates the electric motor to drive the compressor wheel in accordance with a target operational condition of the engine.

Such a turbocharger can advantageously be controlled according to the previously described methods, and thus, substantially the same effects can be obtained.

Other features and advantages of the invention will become apparent from the description that follows with reference being made to the enclosed drawings, in which:

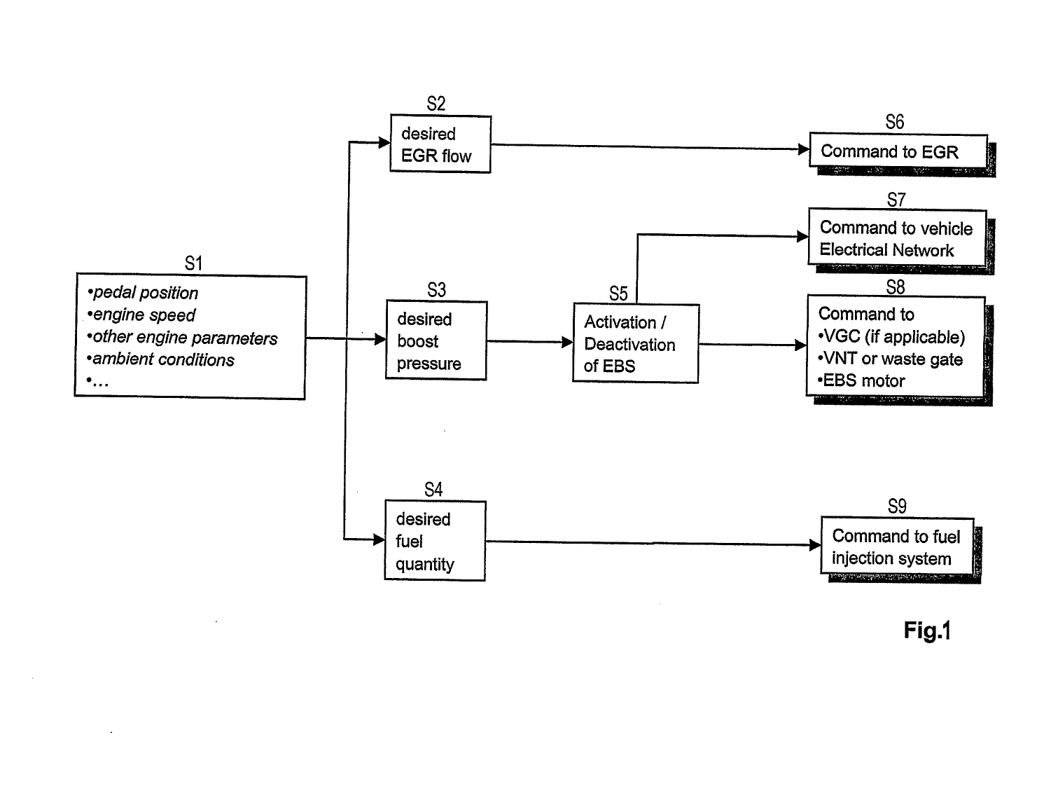

FIG. 1 shows a general flowchart for a control of a turbocharged engine according to the invention;

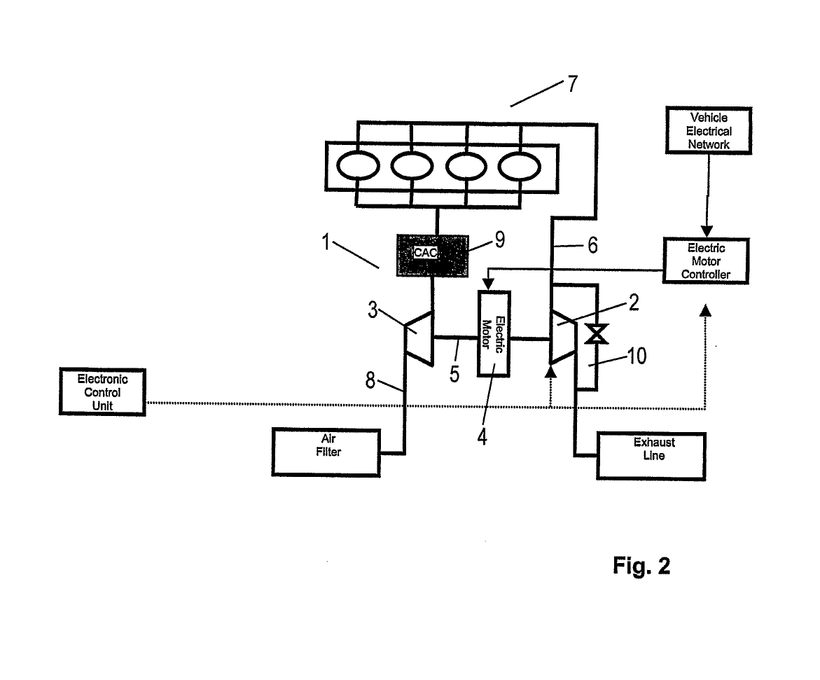

FIG. 2 shows a configuration of an electrically assisted turbocharger for an internal combustion engine according to a first embodiment, wherein the turbine assembly is provided with a waste gate (WG);

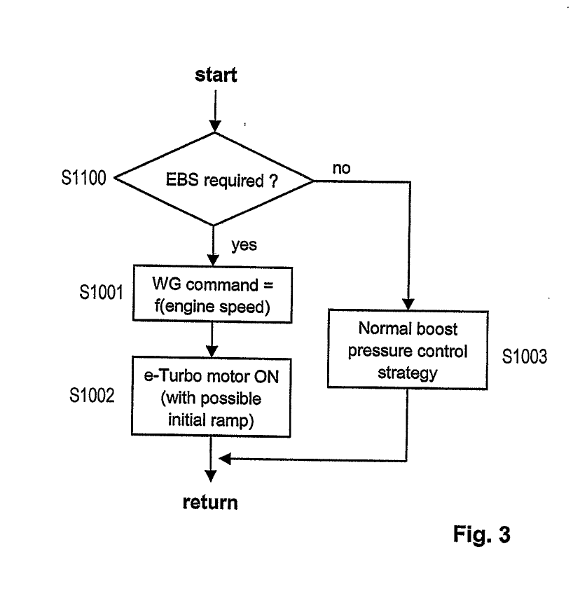

FIG. 3 shows a flowchart for a control of the turbocharger according to the first embodiment when electrical assistance for the turbocharger is required;

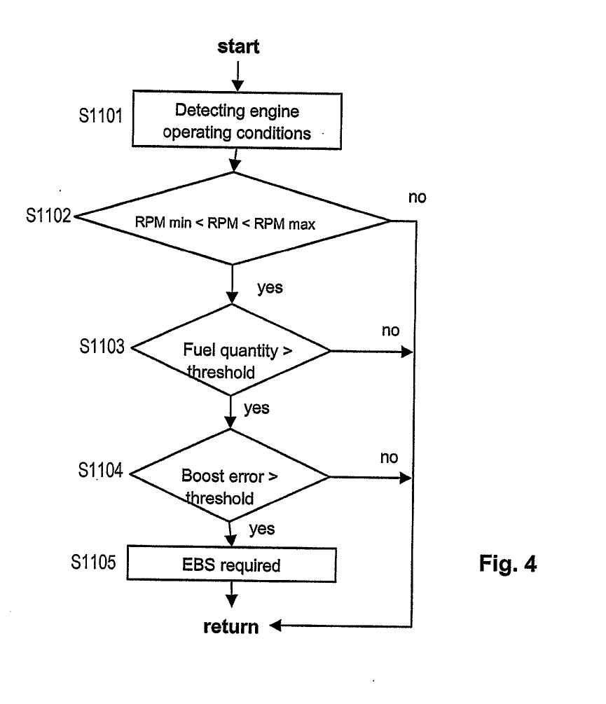

FIG. 4 shows a flowchart for determining whether electrical assistance of the turbocharger is required;

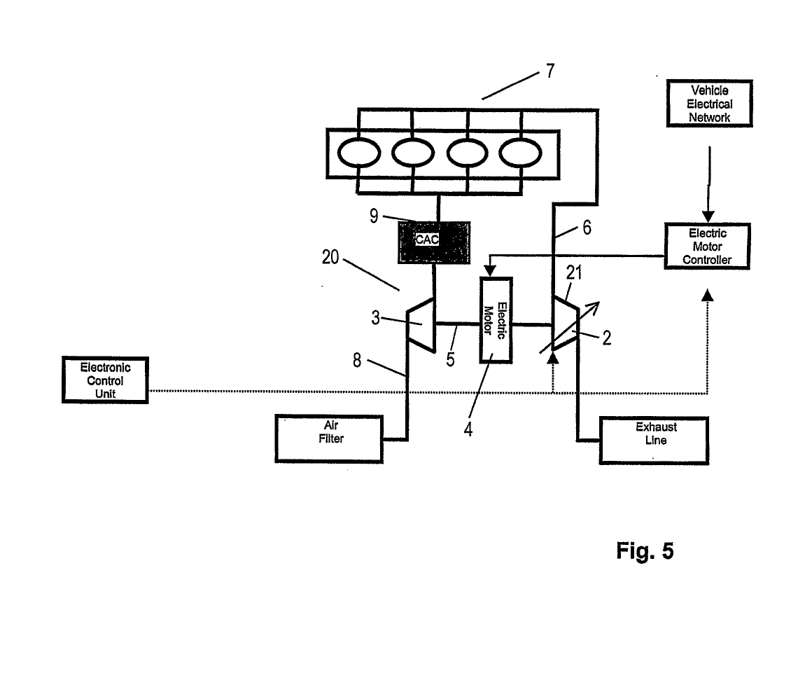

FIG. 5 shows a configuration of an electrically assisted turbocharger for an internal combustion engine according to a second embodiment, wherein the turbine assembly is provided with a variable nozzle turbine (VNT);

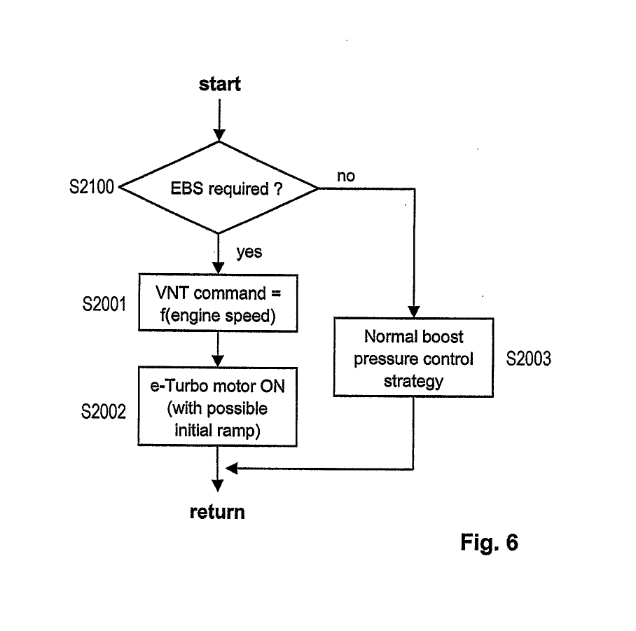

FIG. 6 shows a flowchart for a control of the turbocharger according to the second embodiment when electrical assistance for the turbocharger is required;

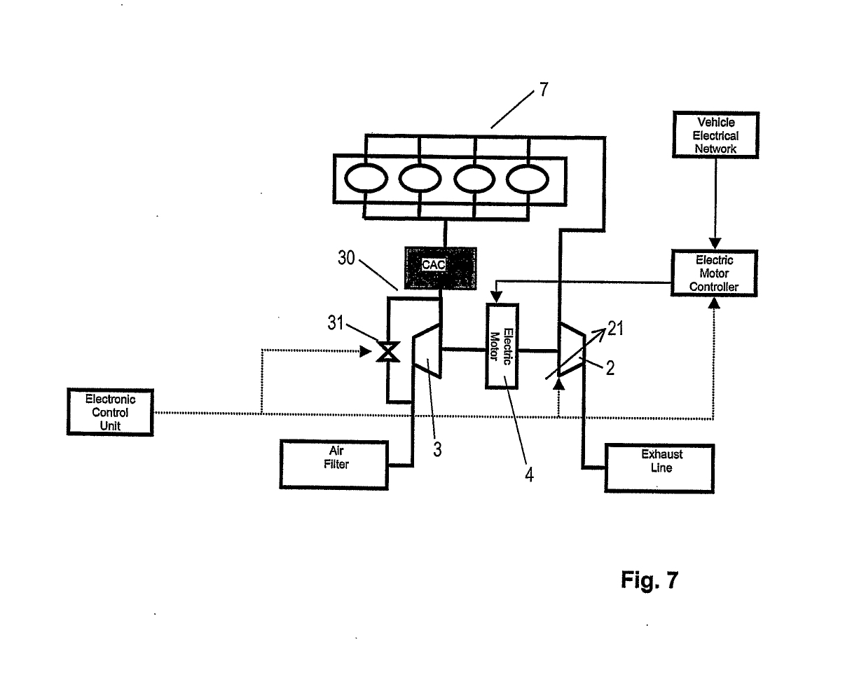

FIG. 7 shows a configuration of an electrically assisted turbocharger for an internal combustion engine according to a third embodiment, wherein the turbine assembly is provided with a variable nozzle turbine and the compressor assembly is provided with a recirculation valve;

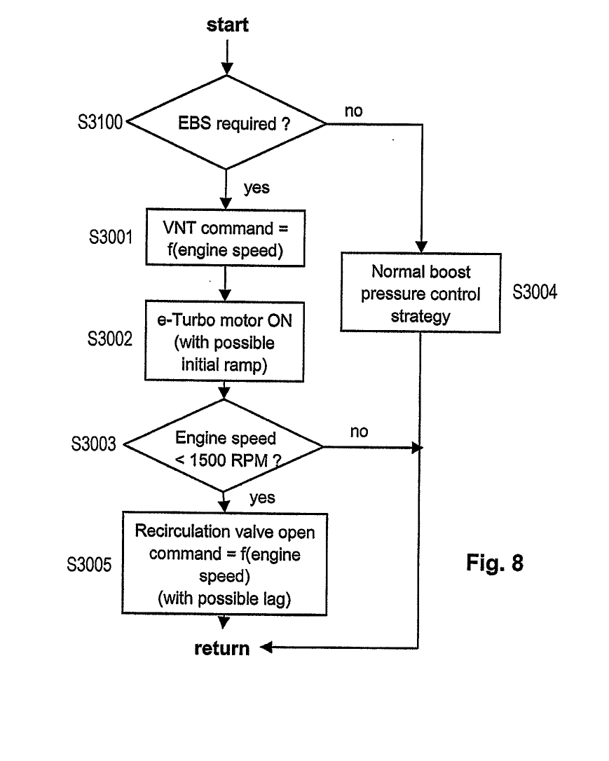

FIG. 8 shows a flowchart for a control of the turbocharger according to the third embodiment when electrical assistance is required;

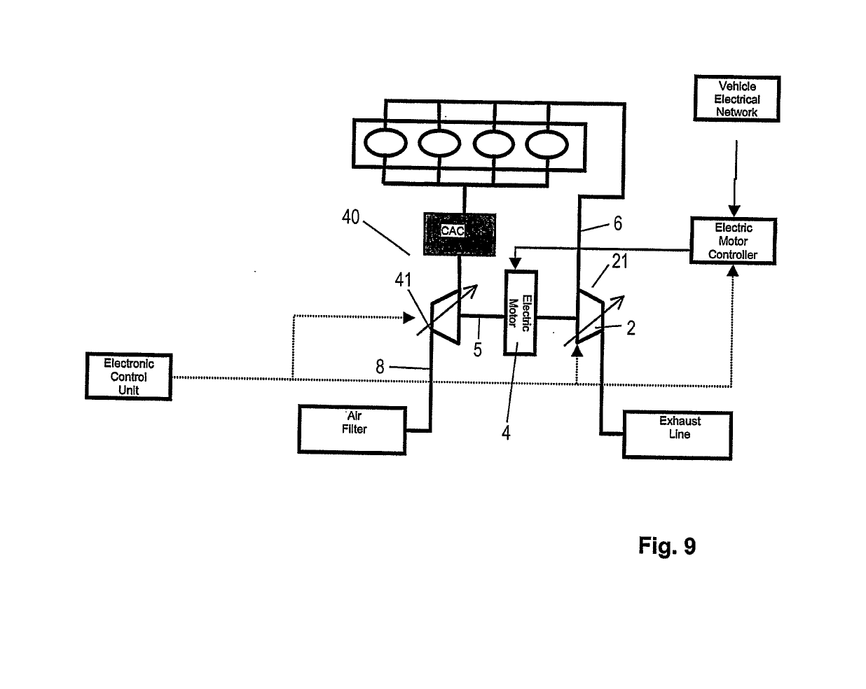

FIG. 9 shows a configuration of an electrically assisted turbocharger for an internal combustion engine according to a fourth embodiment, wherein the turbine assembly is provided with a variable nozzle turbine and the compressor assembly is provided with a variable geometry compressor;

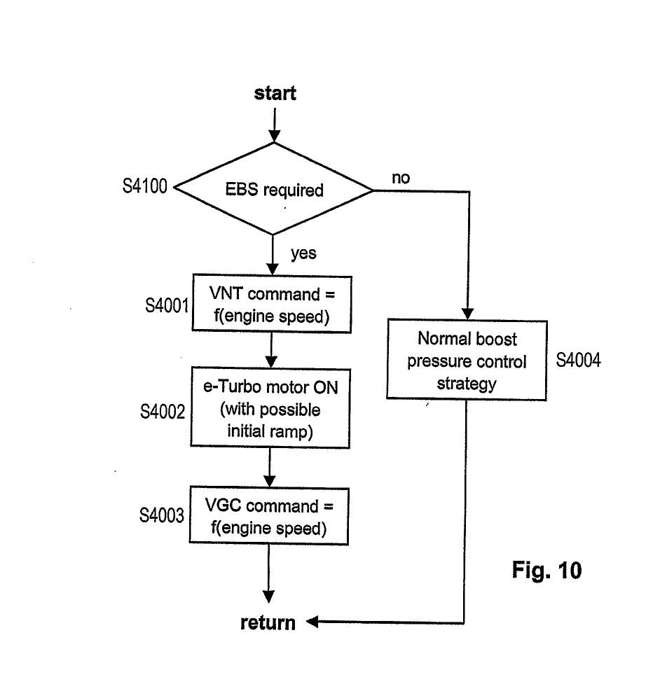

FIG. 10 shows a flowchart for a control of the turbocharger according to the fourth embodiment when electrical assistance is required;

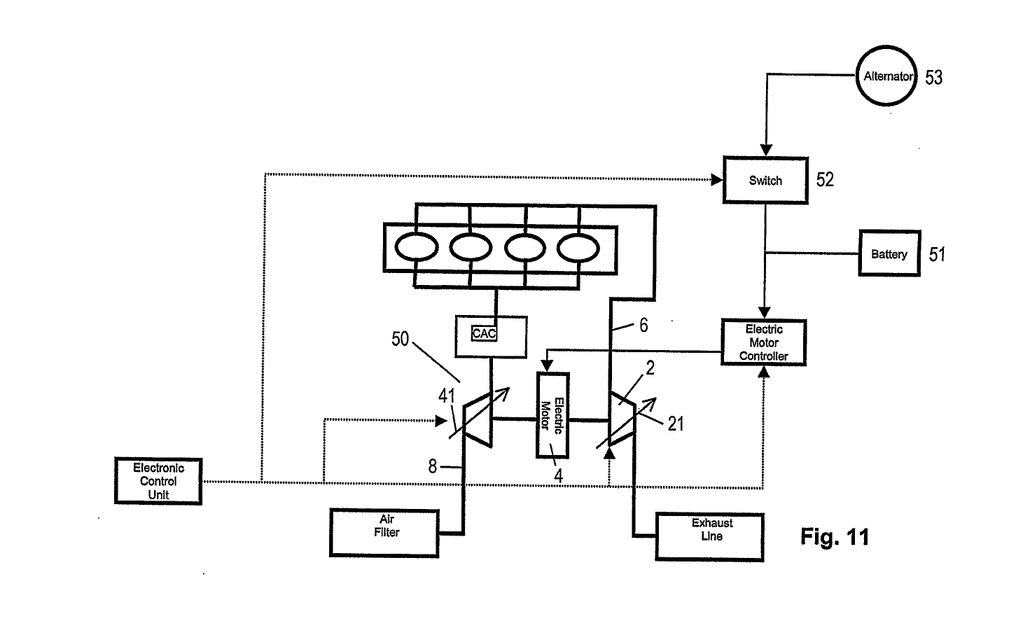

FIG. 11 shows a configuration of an electrically assisted turbocharger for an internal combustion engine according to a fifth embodiment, wherein the electric motor is connected to a vehicle electric network (VEN) comprising an alternator and a battery.

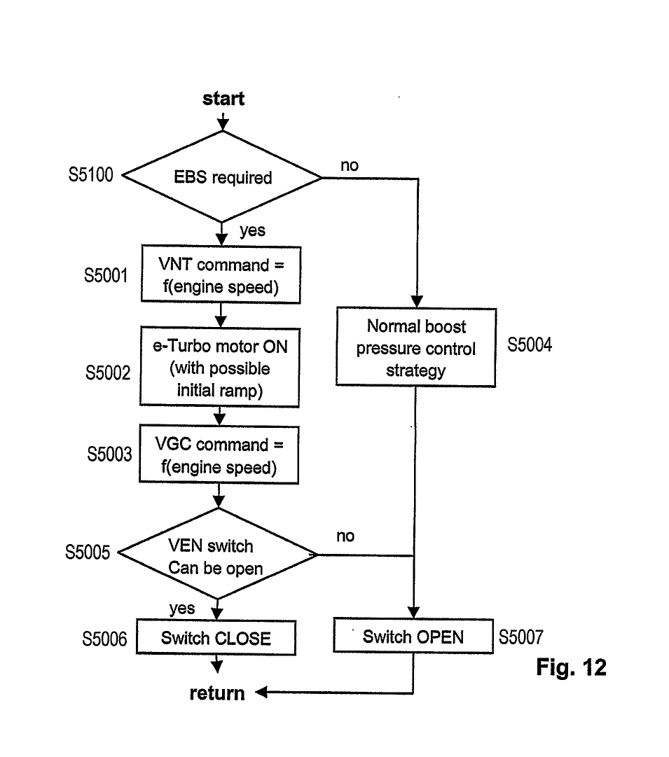

FIG. 12 shows a flowchart for a control of the turbocharger according to the fifth embodiment when electrical assistance for the turbocharger is required;

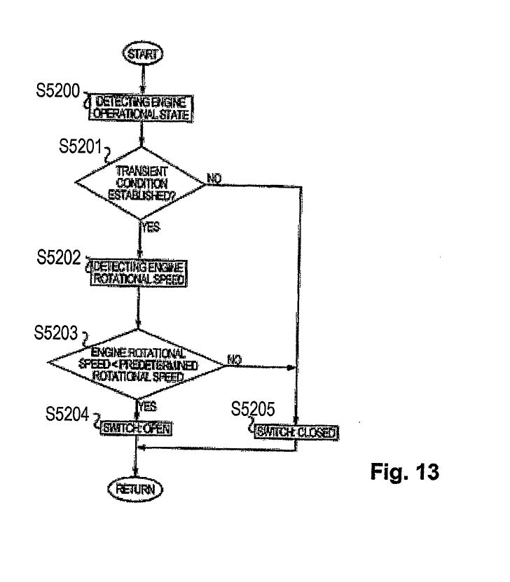

FIG. 13 shows a flowchart for determining whether a switch for connecting/disconnecting the alternator to/from the VEN can be closed/opened.

FIG. 1 shows a flowchart of a general control for a turbocharged engine according to the invention. The engine comprises an exhaust gas recirculation system EGR, an electrically assisted turbocharger, a vehicle electrical network VEN and a fuel injection system. These components will be described more detailed later. Based on input parameters shown in box S1 of FIG. 1, e.g. an acceleration pedal position, an engine speed and other parameters representing the engine and ambient conditions, a desired exhaust gas recirculation flow S2, a desired boost pressure S3 and a desired fuel quantity S4 are determined as output parameters from corresponding maps which are prepared in advance.

Based on the output parameters for a desired EGR-flow S2 and a desired fuel quantity, suitable commands are sent to the exhaust gas recirculation system S6 and the fuel injection system S9, respectively. Furthermore, based on the desired boost pressure S3, a decision is made whether or not an electrical assistance of the turbocharger is to be carried out S5. Based on the result in box S5, appropriate commands are sent to the VEN and the turbocharger, respectively.

Now, various embodiments of such a turbocharged internal combustion engine and of the corresponding controls will be discussed with reference to FIGS. 2 to 13.

According to a first embodiment shown in FIG. 2, a turbocharger 1 of the invention comprises a turbine assembly 2 having a turbine wheel accommodated in a turbine housing, a compressor assembly 3 having a compressor wheel accommodated in a compressor housing, and an electric motor 4 which can also be used as a generator. The turbine wheel and the compressor wheel are provided on a common shaft 5 such that a rotation of the turbine wheel is transmitted to the compressor wheel. The electric motor 4 is arranged to act on the common shaft 5. Preferably, the electric motor is provided at the common shaft 5 wherein the shaft 5 itself serves as a rotor of the electric motor 4. Thus, when the electric motor 4 is operated, the driving of the compressor wheel is assisted by the torque of the electric motor 4 applied to the common shaft 5.

Furthermore, the turbine assembly 2 is connected to an exhaust gas passage 6 connected to an internal combustion engine 7 and supplying exhaust gas from the engine 7 to the turbine assembly 2 so as to drive the turbine wheel. On the other hand, the compressor assembly is connected to an intake air passage 8 such that the compressor wheel compresses the intake air when being driven by the turbine wheel or by the electric motor 4. A charge air cooler or intercooler 9 is provided upstream of the compressor 3 so as to cool the charged or compressed intake air. Furthermore, according to the first embodiment, the turbine assembly 2 is provided with a waste gate 10 which is normally closed such that the whole exhaust gas coming from the engine 7 enters the turbine assembly 2 so as to drive the turbine wheel. However, under certain conditions which will be explained later, the waste gate can be opened such that the exhaust gas coming from the engine partially bypasses the turbine assembly 2. For its opening and closing operations, the waste gate can be electrically or pneumatically actuated by an waste gate actuator. Furthermore, the waste gate can be controlled to be fully and/or partially opened and closed.

An electric control unit ECU is connected to several sensors in the engine as well as to the turbine waste gate actuator and to an electric motor controller. The ECU carries out a control of the electric motor controller and of the waste gate actuator as illustrated in flowcharts shown in FIGS. 3 and 4.

The control shown in FIG. 3 starts with step S1100 for determining whether an electrical assistance of the turbocharger is required or not. Step S1100 contains a sub-control which is shown in detail in FIG. 4 and explained as follows.

In step S1101 of the flowchart shown in FIG. 4, the ECU detects an engine operating condition by reading various sensor values and map related values like a rotational speed of the engine, a fuel quantity and a target boost pressure. Such map related values are prepared in advance. In step 1102, it is determined whether the engine speed RPM ranges between values RPMmin and RPMmax. If in step S1102, the determination is affirmative, the procedure proceeds to step S1103. Otherwise, the procedure returns, determines that an electrical assistance of the turbocharger is not required and a normal boost pressure control strategy is carried out (see step S1003 in FIG. 3).

In step 1103 of FIG. 3, it is determined whether the fuel quantity exceeds a fuel quantity threshold value. If in step S1103, the determination is affirmative, the procedure proceeds to step S1104. Otherwise, the procedure returns and determines that an electrical assistance of the turbocharger is not required.

In Step S1104, it is determined whether a boost error exceeds a boost error threshold. Therein, the boost error can be expressed as
Boost error=P_{boost target}−P_{boost actual}
In other words, the boost error is the difference between the target boost pressure determined in step S1101 and the actual boost pressure which is sensed with a sensor provided in the intake air passage 8 downstream of the compressor assembly 3.

If in step S1104, the determination is affirmative, the procedure proceeds to step S1105. Otherwise, the procedure returns and determines that an electrical assistance of the turbocharger is not required.

Additionally to the conditions explained for steps S1102 to S1104, many other conditions can be used. For example, further conditions, which need to be true or affirmative for determining that electrical assistance of the turbocharger is required may be:
EGR valve closed ?
battery state of charge>threshold value ?
gear ratio value=a set value ? (for example no activation of electrical assistance in first gear)
total activation duration of electric motor<max value (for example 5s)
internal motor temperature<threshold value ?

If all the conditions of steps S1102 to S1104, or also the above-mentioned additional conditions, are true, the procedure proceeds to step S1105. Here, it is determined that an electrical assistance of the turbocharger is required and the procedure returns to step S1100 of FIG. 3.

When the result of step S1100 is negative, i.e. when the procedure of FIG. 4 has put out that an electrical assistance is not required, the procedure of FIG. 3 proceeds to step S1003 and performs a normal boost pressure control strategy as is described below.

In the turbocharger according to the first embodiment wherein the turbine assembly 2 is provided with a waste gate 10, such a normal boost pressure control strategy may be carried out as follows. When the speed of the engine 7 is at a low value, the waste gate actuator is controlled to keep the waste gate 10 closed. Thus, the total exhaust gas mass flow coming from the engine 7 is passed through the turbine assembly for driving the turbine wheel and thus the compressor wheel. As a result, the total exhaust gas mass flow of the engine 7 is used for charging the intake air supplied into the cylinders of the internal combustion engine 7.

Then, when the boost pressure of the intake air, which is charged by the compressor assembly 3, has reached a target boost pressure, the waste gate actuator is controlled to start with opening the waste gate 10. Thus, a part of the exhaust gas coming from the engine 7 bypasses the turbine assembly 2 without contributing to the driving of the turbine wheel. As a result, only a part of air-mass flow coming from the engine is used to drive the turbine wheel. Accordingly, with this control of the waste gate actuator, the boost pressure of the intake air generated by the compressor of the turbocharger can be controlled to meet the target boost pressure.

On the other hand, when the determination of step S1100 of FIG. 3 is affirmative, i.e. when an electrical assistance of the turbocharger is required, the procedure proceeds to step S1001 in which an waste gate command is sent to the waste gate actuator. The waste gate command is based on the engine speed and/or the engine load wherein the latter is represented by a fuel quantity. For example, when the engine speed is below a threshold value, e.g. 2000 rpm, the waste gate actuator is controlled to close the waste gate 10. Then, in step S1002, the electric motor 4 of the turbocharger is switched ON. Then, the process returns to start the control again.

Thus, according to the first embodiment, the driving of the compressor wheel can be activated by controlling the waste gate 10 of the turbine assembly 2 separately, by controlling the electric motor of the turbocharger separately and by controlling the waste gate of the turbine together with the electric motor of the turbocharger in an optimal manner.

For example, when above mentioned conditions are met, according to which an electrical assistance of the turbocharger is not required, the boost pressure control is made by solely controlling the waste gate 10. This is, when the intake air of the engine is to be charged, the waste gate actuator is controlled to be closed so as to increase the boost pressure.

Furthermore, when a condition is met according to which the turbocharger needs electrical assistance, i.e. when the engine speed is low and the boost pressure can not be reached by driving the turbocharger with the exhaust gas only, the electric motor is switched on so as to additionally spin the compressor wheel while the waste gate 10 is closed.

Furthermore, a condition may by met according to which the turbocharger needs electrical assistance while the engine is at a quite high engine speed resulting in an increased exhaust gas mass flow. In this case, the waste gate of the turbine assembly 2 can be controlled to open such that the stronger exhaust gas flow bypasses the turbine wheel. Thus, the turbine assembly can be prevented from being damaged due to an overload. At the same time, the electric motor is switched on, so that the compressor wheel is driven by the electric motor to generate a required intake air boost pressure.

As a result, the turbocharger according to the first embodiment of the invention can be designed to appropriately charge the intake air supplied to the engine over a wide operational range of the engine. This is especially important when the engine is a downsized engine having a small displacement.

Now, a second embodiment is explained with respect to FIGS. 5 and 6.

FIG. 5 shows a configuration of the turbocharger 20 which substantially corresponds to the turbocharger 1 of the first embodiment. However, according to the second embodiment, the turbine assembly 2 is a variable nozzle turbine VNT without a waste gate.

The variable nozzle turbine assembly 2 comprises a turbine housing accommodating a turbine wheel and a variable nozzle device 21. The variable nozzle device 21 has nozzles which can be activated so as to change an inlet sectional area of a throat portion of the turbine assembly 2 leading the exhaust gas to the turbine wheel for driving the same.

Furthermore, the turbocharger 20 according to the second embodiment is provided with an electric motor for electrically assisting the driving of the compressor wheel.

A control of the turbocharger according to the second embodiment is explained with reference being made to the flowchart shown in FIG. 6.

Step S2100 corresponds to step 1100 shown in FIG. 3 and is based on the subroutine shown in FIG. 4 which has already been explained for the first embodiment. Thus an explanation thereof will be omitted.

When the determination of step S2100 is negative, i.e. when electrical assistance of the turbocharger is not required, the procedure proceeds to step S2003 and carries out the normal boost pressure control strategy.

With the turbocharger 20 of the second embodiment, in which the turbine assembly is provided with a variable nozzle device 21, the normal boost pressure control strategy can be described as follows.

When the mass flow of the exhaust gas coming from the engine is small, the nozzles of the variable nozzle device 21 are controlled to decrease the inlet sectional area of the throat portion such that the exhaust gas pressure on the turbine wheel is increased. Then, when the mass flow of the exhaust gas increases, e.g. when the engine speed increases, the nozzles are controlled to open so as to enlarge the inlet area of the throat portion. Thus, a backpressure upstream the turbine is held substantially constant while the higher mass flow of the exhaust gas is used to drive the turbine wheel. The activation of the variable nozzle device 21 during the normal boost pressure control strategy can be carried out depending on the actual boost pressure.

On the other hand, when the determination of step S2100 is affirmative, i.e. when an electrical assistance of the turbocharger is required, the procedure proceeds to step S2001 in which an VNT-command is sent to the variable nozzle device 21 of the turbine assembly 2. The VNT-command is based on the engine speed and/or the engine load wherein the latter is represented by a fuel quantity. For example, when the engine speed is below a threshold value, e.g. 1500 rpm, the variable nozzle device 21 is controlled to reduce the inlet area of the throat portion so as to increase the pressure on the turbine wheel. Then, in step S2002, the electric motor 4 of the turbocharger is switched ON, wherein an initial ramp in the duty ratio of the electric motor may be advantageous to overcome a turbo lag. Subsequently, the process returns to start the control again.

Thus, according to the second embodiment, the driving of the compressor wheel of the turbocharger can be activated by controlling the variable nozzle device 21 of the turbine assembly separately, by controlling the electric motor 4 of the turbocharger separately and by controlling the variable nozzle device 21 of the turbine assembly 2 together with the electric motor of the turbocharger.

As a result, the turbocharger according to the second embodiment can be dimensioned to appropriately charge the intake air supplied to the engine over a wide operational range of the engine. In other words, the map width of the turbocharger is further enhanced. This is especially important when the engine is a downsized engine having a small displacement.

Next, a third embodiment of the turbocharger according to the invention is described based on FIGS. 7 and 8.

The turbocharger 30 shown in FIG. 7 substantially corresponds to that of the second embodiment of FIG. 5. In addition to the provision of the variable nozzle device 21 at the turbine assembly 2, a recirculation valve 31 is provided at a recirculation passage for recirculation of the intake air having passed the compressor assembly. That is, when the recirculation valve 31 is open, the intake air downstream of the compressor assembly is recirculated to the upstream side of the compressor assembly.

FIG. 8 shows a flowchart illustrating a control of the turbocharger 30 of the third embodiment. Therein, step S3100 for determining whether or not electrical assistance of the turbocharger is required corresponds to step S1100 in FIG. 3 and is based on the subroutine shown in FIG. 4 which has already been explained for the first embodiment. Thus an explanation thereof will be omitted.

When the determination in step S3100 is negative, the procedure proceeds to step S3004 and a normal boost pressure control strategy is carried out. This normal boost pressure control strategy corresponds to that already explained for the second embodiment, and thus, an explanation thereof will be omitted.

On the other hand, when the determination of step S3100 is affirmative, i.e. when an electrical assistance of the turbocharger is required, the procedure proceeds to step S3001 in which a VNT-command is sent to the variable nozzle device 21 of the turbine assembly 2. The VNT-command is based on the engine speed and/or the engine load which is represented by a fuel quantity as already explained for the second embodiment. Then, in step S3002, the electric motor 4 of the turbocharger is switched ON. Subsequently, the process proceeds to step S3003.

In Step S3003, a decision is made whether or not the engine speed is below 1500 rpm. If this decision is affirmative, the procedure proceeds to step S3005 and controls the recirculation valve 31 to open. If the decision in step S3003 is negative, the process returns to start the control again.

In step S3005, a recirculation valve open command is send to the recirculation valve 31. That is, when the engine speed is below above-mentioned threshold value while the electric motor is operating, the recirculation valve is controlled to open. For performance reasons, it might be useful to have a time delay before the recirculation valve opens. By contrast, when the engine speed is higher than the threshold value, the recirculation valve is closed. Namely, in case the driving of the compressor wheel is electrically assisted while the engine is at a low engine speed, particularly between 1000 and 1500 rpm, compressor surge may occur. This is, at this low engine speed, the electric motor may drive the compressor wheel so fast that fluctuations in mass flow and pressure in the compressor assembly are highly increased. Accordingly, at this engine speed range and when the electric motor is running, the recirculation valve 31 is controlled to open so as to prevent the occurrence of compressor surge.

As a result, the turbocharger according to the third embodiment can be dimensioned to appropriately charge the intake air supplied to the engine over a further widened operational range of the engine. In other words, the map width of the turbocharger is still further enhanced. This is especially important when the engine is a downsized engine having a small displacement.

In the following, a fourth embodiment of a turbocharger 40 is explained with reference being made to FIGS. 9 and 10.

FIG. 9 shows a configuration of the turbocharger 40 which substantially corresponds to that of the second embodiment. Furthermore, the turbocharger according to the fourth embodiment is provided with a variable geometry compressor 41 as a compressor.

The variable geometry compressor 41 may be one of the type having a variable nozzle wherein a vane is positioned in a nozzle passage through which the inlet air passes when being compressed. By changing the position of the vane, a nozzle passage area and/or a nozzle passage direction is/are adjusted. Thus, the vane can be operated such that a compressor surge can be delayed.

FIG. 10 shows a flowchart which illustrates the control of the turbocharger of the fourth embodiment. Therein, step S4100 for determining whether or not electrical assistance of the turbocharger is required corresponds to step S1100 of FIG. 3 and is based on the subroutine shown in FIG. 4 which has already been explained for the first embodiment. Thus an explanation thereof will be omitted.

When the determination in step S4100 is negative, the procedure proceeds to step S4004 and a normal boost pressure control strategy is carried out. This normal boost pressure control strategy corresponds to that already explained for the second embodiment, and thus, an explanation thereof will be omitted.

On the other hand, when the determination of step S4100 is affirmative, i.e. when an electrical assistance of the turbocharger is required, the procedure proceeds to step S4001 in which an VNT-command is sent to the variable nozzle device 21 of the turbine assembly. The VNT-command is based on the engine speed and/or the engine load as already explained for the second embodiment. Then, in step S4002, the electric motor of the turbocharger is switched ON. Subsequently, the process proceeds to step S4003.

In step S4003, a VGC-command is sent to the variable geometry compressor so as to control the variable geometry of the compressor based on the engine speed. That is, in a state of a low engine speed, the vane is set such that the nozzle area is small. Then, when the engine speed reaches a certain value, the vanes are controlled to open. In this embodiment, the position of the vanes can be controlled according to a calibrated look up table which is based on the engine speed. This lookup table can have correctors depending on the altitude at which the vehicle is running.

Thus, according to the fourth embodiment, the position of the vanes of the variable geometry compressor are appropriately adjusted when the compressor is assisted by the electric motor.

As a result, the turbocharger according to the fourth embodiment can be dimensioned to appropriately charge the intake air supplied to the engine over a further widened operational range of the engine. In other words, the map width of the turbocharger is still further enhanced. This is especially important when the engine is a downsized engine having a small displacement.

In the following, a fifth embodiment of a turbocharger 50 is explained with reference being made to FIGS. 11 to 13.

FIG. 11 shows a configuration of the turbocharger 50 which substantially corresponds to that of the fourth embodiment. Furthermore, the turbocharger according to the fifth embodiment is supplied with electric power from a vehicle electrical network (VEN) including an alternator 53, a switch 52 and a battery 51. The switch 52 is controlled by the ECU so as to connect/disconnect the alternator to/from the electric motor of the turbocharger by closing/opening the switch.

A flowchart of the control for the turbocharger 50 according to the fifth embodiment is shown in FIG. 12. Here, the steps S5001 to S5004 are identical to the steps S4001 to S4004 of the fourth embodiment shown in FIG. 10 and a description thereof is therefore omitted. Furthermore, the flowchart of FIG. 11 additionally contains the steps S5005 to S5007. Step S5005 follows step S5003 and will be carried out in case in step S5100 it is determined that an electrical assistance of the turbocharger is required. In step S5005 it is determined whether or not the switch 52 can be opened for disconnecting the alternator from the VEN according to the flowchart shown in FIG. 13.

In the procedure shown in FIG. 13, the engine operational state is detected in step S5200 and it is determined in step S5201, whether or not a transient condition of the engine is established. If the determination in step S5201 is negative, the switch is set to the closed position in step S5205. Then, the procedure returns to the start and is repeated.

If the determination in step S5201 is affirmative, in step S5202 an engine speed is detected and the procedure proceeds to step S5203.

In step S5203 it is determined whether or not the engine speed is less than a predetermined rotational speed. If the engine speed is less than a predetermined rotational speed, an affirmative determination is obtained in step S5203. If the engine speed is equal to or higher than the predetermined rotational speed, a negative determination is obtained in step S5203.

If a negative determination is obtained in step S5203, the switch is set to the closed position in step S5205. Then, the routine returns to the start. If an affirmative determination is obtained in step S5203, the switch is set to the open position in step S5204. Then the routine returns to the start and is repeatedly carried out by the electronic control unit.

According to the fifth embodiment of the present invention as shown in FIG. 13, the engine speed is detected in step S5202 and the switch is set to the open position in step S5204 in case that the engine speed is less than a predetermined rotational speed. Therefore, the switch is kept open until the rotational speed of the engine reaches a predetermined rotational speed and during the this period, the electric motor 4 of the turbocharger is supplied with electric power not from the alternator but from the battery 51, only. Then, when the actual engine speed reaches the predetermined engine speed, the switch 52 is closed and the electric motor of the turbocharger is connected to the alternator 53.

In other words, in the beginning of the electrical assistance of the turbocharger, electric power is supplied to the electric motor 4 from the battery 51 only, and when the rotational speed of the engine has reached a predetermined value, electric power is supplied to the electric motor 4 of the turbocharger also from the alternator 53. Thus, a drag torque on the crank shaft resulting from a high electric power demand of the electric motor 4 being applied to the alternator when the engine speed is low can be prevented.

Preferably, the battery 51 is exclusively used for the electric motor 4 of the turbocharger while another battery is provided for other components of the vehicle electric network (VEN) like lights, a fan and so on.

Thus, a stable condition of the VEN is secured because when the electric motor demands a high amount of electricity, especially in the beginning of the electrical assistance of the compressor wheel, a voltage drop at the above-mentioned other components of the VEN can be prevented from occurring since the electric motor of the turbocharger is supplied with electric power from the battery 51, only.

1. A method for controlling an electrically assisted turbocharger (1; 20; 30; 40; 50) comprising
a compressor assembly (3) having a compressor wheel for compressing a fluid to an engine (7);
a turbine assembly (2) having a turbine wheel driven by an exhaust gas of the engine and driving the compressor wheel; and
an electric motor (4) for electrically driving the compressor wheel,
wherein
at least the turbine assembly (2) comprises a variation means (10; 21) for varying an operational condition of the turbine assembly (2);
the method comprising the steps of
judging that the actual operational condition of the engine (7) requires electrical driving of the compressor wheel;
controlling said variation means (10; 21) in accordance with a rotational speed of the engine (7), and
operating the electric motor (4) to drive the compressor wheel in accordance with a target operational condition of the engine (7).

2. A method for controlling an electrically assisted turbocharger (1; 20; 30; 40; 50) comprising
a compressor assembly (3) having a compressor wheel for compressing a fluid to an engine (7);
a turbine assembly (2; 21) having a turbine wheel driven by an exhaust gas of the engine and driving the compressor wheel; and
an electric motor (4) for electrically driving the compressor wheel,
wherein
at least the turbine assembly (2) comprises a variation means (10; 21) for varying an operational condition of the turbine assembly;
the method comprising the steps of
judging that the actual operational condition of the engine (7) requires electrical driving of the compressor wheel;
controlling said variation means (10; 21) in accordance with an engine load, and
operating the electric motor (4) to drive the compressor wheel (7) in accordance with a target operational condition of the engine (7).

3. The method according to claim 2, wherein the engine load is represented by an amount of fuel injected into a cylinder of the engine (7).

4. The method according to any of claims 1 to 3, wherein the judgement of the actual operational condition the engine (7) is determined based on the rotational speed of the engine.

5. The method according to any of claims 1 to 4, wherein the judgement of the actual operational condition of the engine (7) is determined based on a fuel quantity.

6. The method according to any of claims 1 to 5, wherein the judgement of the actual operational condition of the engine (7) is determined based on a boost error.

7. The method according to claim 6, wherein the electrical driving of the compressor wheel is judged to be necessary if
the rotational speed of the engine (7) is within a certain range,
the fuel quantity has reached a certain fuel quantity threshold value, and
the boost error has reached a certain boost error threshold value.

8. The method according to any of claims 1 to 7, wherein
the compressor assembly (3) is a fixed geometry compressor assembly,
the turbine assembly (2) is a waste gate turbine, and
the variation means is a waste gate (10) varying the amount of exhaust gas supplied to the turbine wheel,
the method comprising the step of
controlling a waste gate position so as to adjust the operational condition of the turbine wheel.

9. The method according to any of claims 1 to 7, wherein
the compressor assembly (3) is a fixed geometry compressor assembly,
the turbine assembly (2) is a variable nozzle turbine, and
the variation means is a variable nozzle device (21) varying the flow of exhaust gas supplied to the turbine wheel,
the method comprising the step of
controlling a variable nozzle position so as to adjust the operational condition of the turbine wheel.

10. The method according to claim 9, wherein
the compressor assembly comprises a recirculation valve (31) as a variation means,
the method further comprising the step of
controlling the recirculation valve (31) so as to adjust the operational condition of the compressor wheel.

11. The method according to claim 9, wherein
the compressor assembly is a variable geometry compressor (41) comprising at least one vane as a variation means, the method further comprising the step of
controlling the position of the at least one vane so as to adjust the operational condition of the compressor wheel.

12. The method according to claim 11, wherein the electrically driven turbocharger (50) is supplied with electric power from a vehicle electrical network (VEN) including an alternator (53), a controllable switch (52) and a battery (51), wherein the switch (52) is switchable to connect/disconnect the electric motor (4) from the alternator (53), the method further comprising the step of
operating said switch (52) in the beginning of the electrical driving of the compressor wheel such that the electric motor (4) is supplied with electric power from the battery (51), only.

13. A turbocharging device having an electrically assisted turbocharger (1; 20; 30; 40; 50) and a control means (ECU) for controlling said turbocharger (1; 20; 30; 40; 50), the turbocharger further comprising:
a compressor assembly (3) having a compressor wheel for compressing a fluid to an engine (7);
a turbine assembly (2) having a turbine wheel driven by an exhaust gas of the engine (7) and driving the compressor wheel; and
an electric motor (4) for electrically driving the compressor wheel, wherein
at least the turbine assembly (2) comprises a variation means (10; 21) for varying an operational condition of the turbine assembly (2); wherein
the control means (ECU)
judges that the actual operational condition of the engine (7) requires electrical driving of the compressor wheel;
controls said variation means in accordance with a rotational speed of the engine (7), and
operates the electric motor (4) to drive the compressor wheel in accordance with a target operational condition of the engine.

14. A turbocharging device having an electrically assisted turbocharger (1, 20; 30; 40; 50) and a control means (ECU) for controlling said turbocharger, the turbocharger further comprising:
a compressor assembly (3) having a compressor wheel for compressing a fluid to an engine;
a turbine assembly (2) having a turbine wheel driven by an exhaust gas of the engine and driving the compressor wheel; and
an electric motor (4) for electrically driving the compressor wheel, wherein
at least the turbine assembly (2) comprises a variation means (10; 21) for varying an operational condition of the turbine assembly (2); wherein
the control means (ECU)
judges that the actual operational condition of the engine (7) requires electrical driving of the compressor wheel;
controls said variation means (10; 21) in accordance with an engine load, and
operates the electric motor (4) to drive the compressor wheel in accordance with a target operational condition of the engine (7).

15. A turbocharging device according to claim 14, wherein the engine load is represented by an amount injected in to a cylinder of the engine (7).

16. The turbocharging device according to any of claims 13 to 15, wherein the judgement of the actual operational condition the engine (7) is determined based on the rotational speed of the engine.

17. The turbocharging device according to any of claims 13 or 16, wherein the judgement of the actual operational condition of the engine (7) is determined based on a fuel quantity.

18. The turbocharging device according to any of claims 13 to 17, wherein the judgement of the actual operational condition of the engine (7) is determined based on a boost error.

19. The turbocharging device according to any of claims 13 to 15, wherein the electrical driving of the compressor wheel is judged to be necessary if
the rotational speed of the engine (7) is within a certain range,
the fuel quantity has reached a certain fuel quantity threshold value, and
the boost error has reached a certain boost error threshold value.

20. The turbocharger according to any of claims 13 to 19, wherein
the compressor assembly (3) is a fixed geometry compressor assembly,
the turbine assembly (2) is a waste gate turbine, and
the variation means is a waste gate (10) varying the amount of exhaust gas supplied to the turbine wheel,
wherein the control means (ECU) controls a waste gate position so as to adjust the operational condition of the turbine wheel.

21. The turbocharger according to any of claims 13 to 15, wherein
the compressor assembly (3) is a fixed geometry compressor assembly,
the turbine assembly (2) is a variable nozzle turbine, and
the variation means (ECU) is a variable nozzle device (21) varying the flow of exhaust gas supplied to the turbine wheel,
wherein the control means (ECU) controls a variable nozzle position so as to adjust the operational condition of the turbine wheel.

22. The turbocharging device according to claim 21, wherein
the compressor assembly (3) comprises a recirculation valve (31) as a variation means,
wherein the control means controls the recirculation valve (31) so as to adjust the operational condition of the compressor wheel.

23. The turbocharging device according to claim 21, wherein
the compressor assembly is a variable geometry compressor (41) comprising at least one vane as a variation means, and
the controlling device controls the position of the at least one vane so as to adjust the operational condition of the compressor wheel.

24. The turbocharging device according to claim 23, wherein the electrically driven turbocharger (50) is supplied with electric power from a vehicle electrical network (VEN) including an alternator (53), a controllable switch (52) and a battery (51), wherein the switch (52) is switchable to connect/disconnect the electric motor (4) from the alternator (53), wherein
the controlling device operates said switch (52) in the beginning of the electrical driving of the compressor wheel such that the electric motor (4) is supplied with electric power from the battery, only.
